(19) United States
(12) Patent Application Publication
(10) Pub. No.: US 2006/0286523 A1
(43) Pub. Date: Dec. 21, 2006

(54) Athletic swing training harness

(76) Inventor: Dennis Fogarty, Naples, FL (US)

Correspondence Address: DENNIS FOGARTY, 5120 CERROMAR DRIVE, NAPLES, FL, 34112, US

(21) Appl. No.: 11/492,155

(22) Filed: Jul. 25, 2006

Related U.S. Application Data
(63) Continuation-in-part of application No. 10/753,744, filed on Jan. 8, 2004.

(51) Int. Cl. A63B 69/00; G09B 19/00

(52) U.S. Cl. 434/247

(57) ABSTRACT

It can be difficult to teach the athlete to coordinate his arms and his body during an athletic swing. The natural tendency Is to think of an athletic swing as event that happens with the arms. The thought Is that the arms control the hitting device back and forward to swing at the object to be struck Arms have many moving parts to control and as such it Is difficult to pull a hitting device back and then deliver it forward to perform a solid connection with the ball. The body is a stronger and better instrument for delivering a hitting device back and forth. The body can simply turn to bring the device back and then turn back to deliver It to the starting position. In hitting a ball, it is best If the arms do little work and re an extension of the body. To train the arms and body to be in sync during the hitting motion is Important. Even with the understanding of this concept, the arms and the body may remain two independent elements during the athletic swing motion. The Athletic Swing Training Harness easily keeps the arms and body “connected” by having the arms and torso press lightly into the harness's specialized foam pads. Automatically the arms and body are in sync during the swing motion resulting in a more controlled swing. As the body and arms swing back and then forth in unison, the chances of hitting the object to be struck squarely is greatly enhanced. The struck object will fly in a straight direction and often fly faster/further because of the torque delivered by a body/arm swing that is “connected”.

### CROSS-REFERENCE TO RELATED APPLICATIONS

This specification is a continuation in part from application Ser. No. 10/753,744. Examiner is Victor K. Hwang

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK

Not Applicable

### APPENDIX

Not Applicable

### BACKGROUND OF THE INVENTION

The field of endeavor to which this invention pertains is the function of golf training. The invention aids in executing the optimal swing action that results in better control of the direction of the ball that is struck. In golf, the most effective swing action is when the arms are in sync and “connected” to the body. When this “connected” swing occurs, it results in more control distributed to the object to the golf ball. If the arms are not “connected” to the body during a golf swing, unintended ball flight can occur, i.e. a slice in golf. This concept of keeping the arms tucked into the body can be difficult to conceive of and execute especially for beginners/amateurs in a swing sport.

### BRIEF SUMMARY OF INVENTION

The Athletic Swing Training Harness is a device that assists the body to make more productive golf swings with the arms held dose to the body. Golf swings that occur In this manner deliver straighter ball flight with more power delivered to the golf ball. The Athletic Swing Training Harness helps golfers to hold their arms into the body when swinging. When properly used, it keeps golfers from swinging with just arms or arms that are not in sync with the body's natural swing movement. The Athletic Swing Training Harness positions flexible pads between the upper arm and body which when squeezed automatically keep the arms close to the body, the most productive swing position. The pads are held in place by a strap mechanism which goes behind the neck enabling the pads to hang over the pectoral area until the golfer inserts the pads under the left and right arm.

### BRIEF DESCRIPTION OF DRAWINGS

FIG. 1 is the Athletic Swing Training Harness revealing all the elements of the Athletic Swing Training Harness. There are two (2) pads that are designed to fit under each arm. The pads are constructed of specialized pressed foam covered in fabric forming an “L” shaped piece. The top area above the “L” shaped pad is ribbed to provide that it bend to the contour of the side of the chest. The bottom of the “L” shaped pad is thicker and enables the user of the Athletic Swing Training Harness to squeeze the pad comfortably between the inside arm and torso. The adjustable neck strap is made of elastic with Velcro tabs at each end. The adjustable elastic neck strap is inserted through a slit at the top of each pressed foam pad so that the Velcro tab on the back of each end can be connected to the Velcro compatible backside of each pressed foam piece to ensure that the pads will fit comfortably under each arm regardless of the size of the user. A thin elastic piece fits into the “heel” slot in each pressed foam piece to create tension between the two (2) pads after the pads are inserted under the arms so that the pads will be pulled from under the arms of the user if the user is not applying sufficient pressure to hold the pads in place in the arm pit.

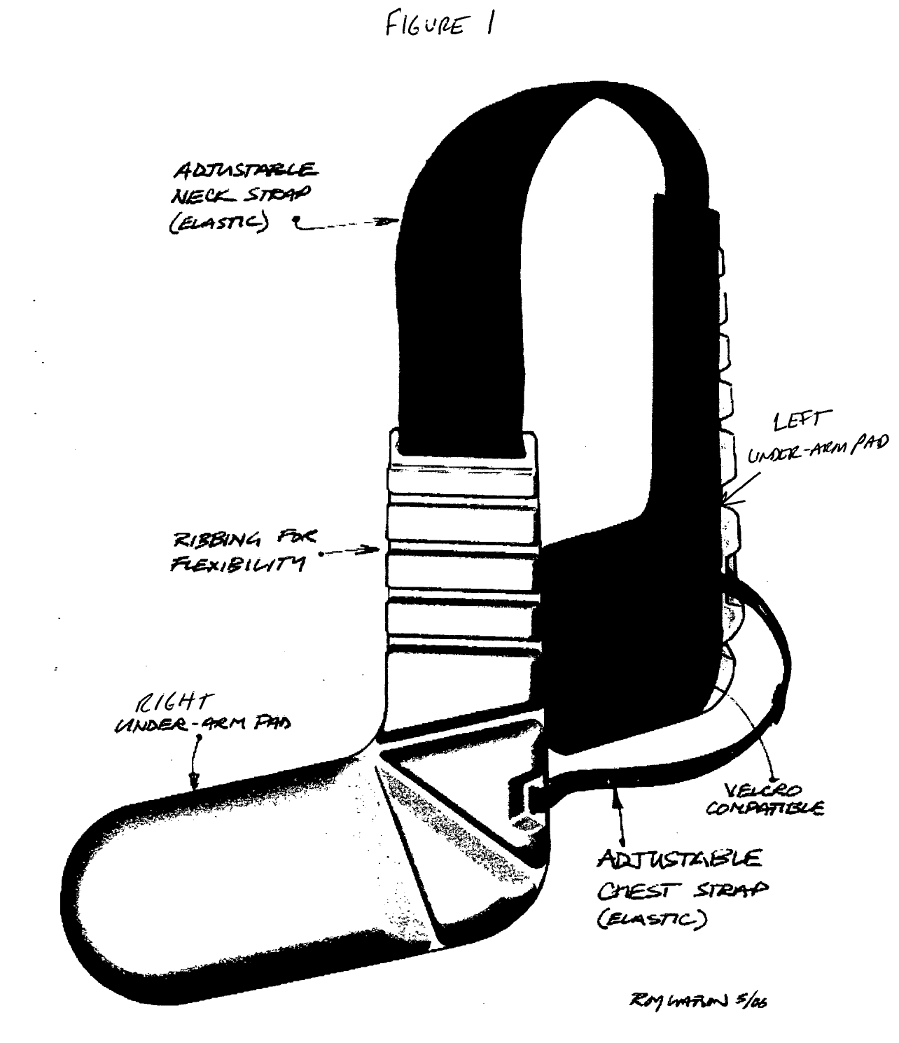

FIG. 2 shows the dimensions of the specialized pressed foam pieces.

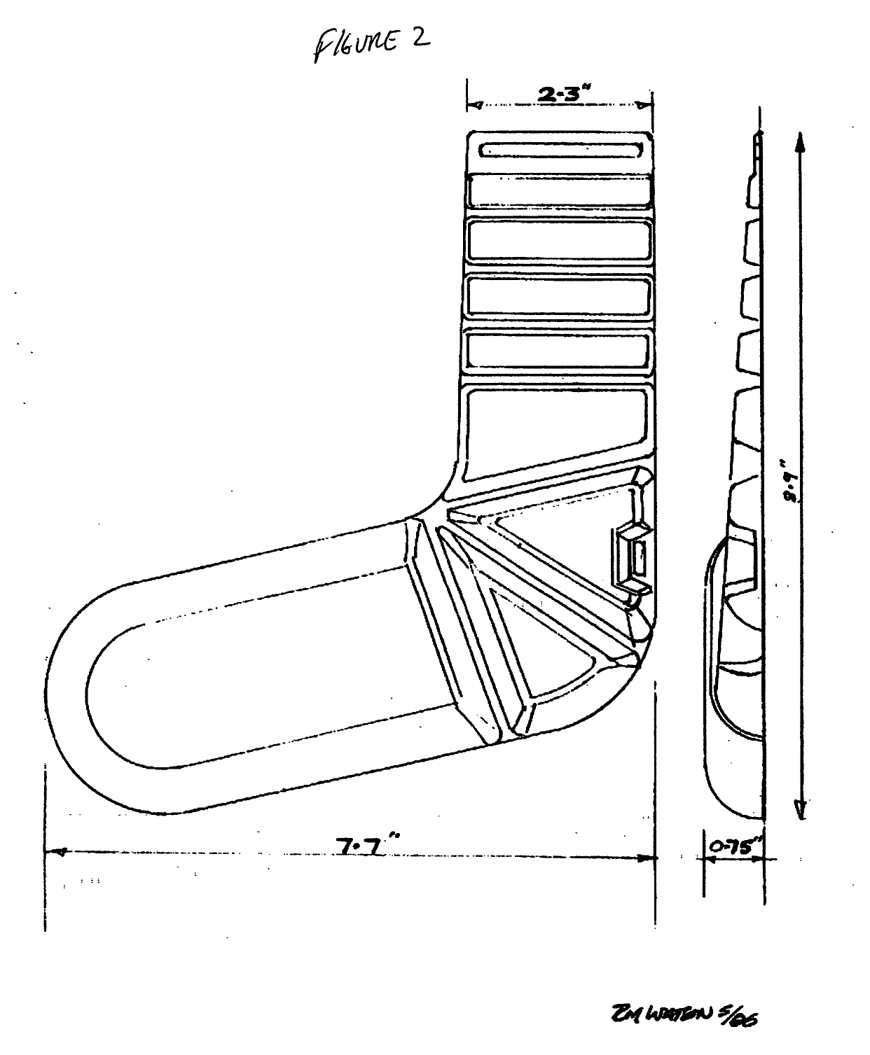

FIG. 3 shows the Athletic Swing Training Harness hanging over neck with specialized pressed foam pieces dangling across the chest prior to the insertion of the pads under the arms.

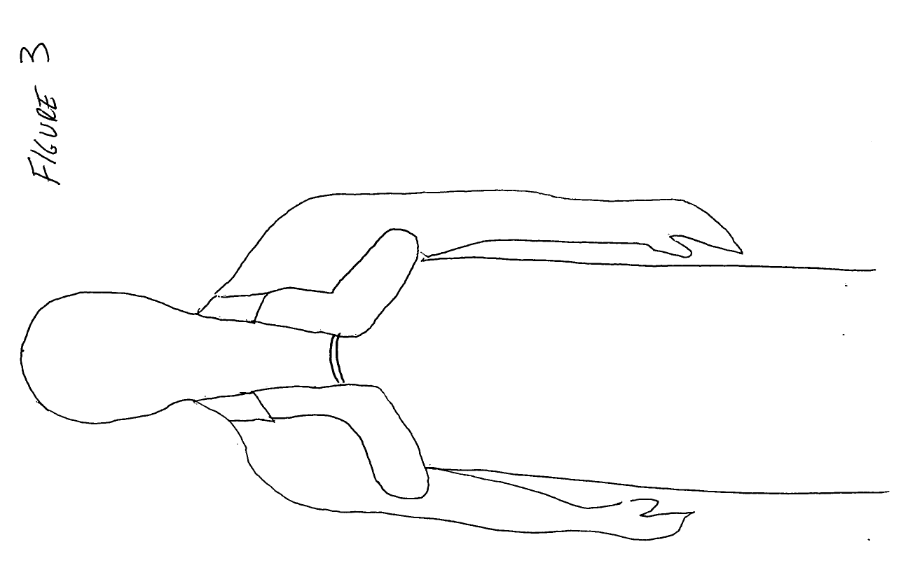

FIG. 4 shows the Golf Swing Training Harness fitted around the neck with the specialized pressed foam pads inserted in position under the arms.

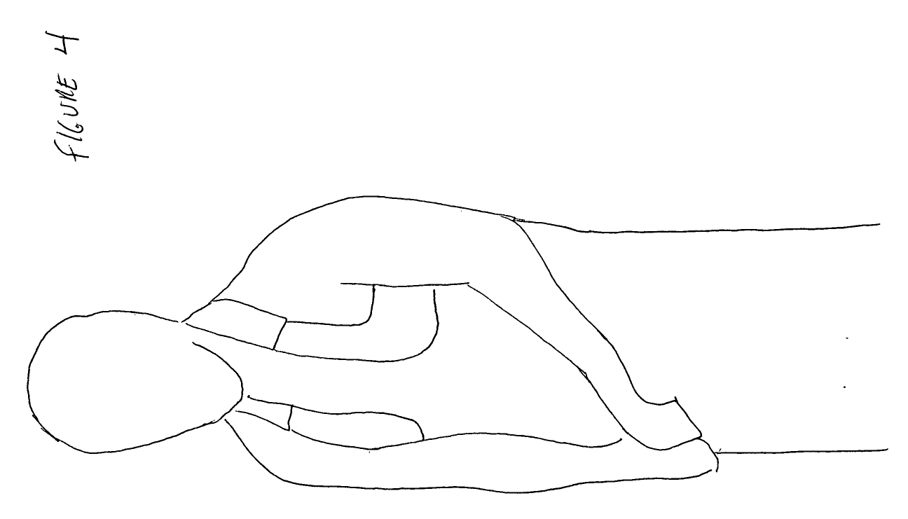

### DETAILED DESCRIPTION OF THE INVENTION

The Athletic Swing Training Harness has two (2) specialized pressed foam pads that are designed to fit under each arm. The pads are part of a single piece of pressed foam forming an “L” shaped piece. The top area above the “pad” section is ribbed to allow this section of the pad bend to the contour of the chest when the pads are being held in place under the user's arms. The bottom area of the pads are thicker and provide flexibility when the user squeezes that portion of the pad between the arm and the torso. The pressed foam pieces are covered in cotton on the front and Velcro compatible material on the back. The adjustable neck strap is made of elastic with Velcro tabs at each end. The adjustable neck strap is inserted through a slit at the top of each pressed foam piece and fixed at the most comfortable position to the Velcro compatible backside of each pressed foam piece. A thin elastic piece fits Into the “heel” slot in each pressed foam piece to create tension between the two (2) pads so that the pads will pull out from under the arms if the user is not applying enough pressure to keep them secure.

After properly putting the elements of the Athletic Swing Training Harness together to ensure the proper fit of the elements to the users body, the user inserts the lower portion of the pressed foam pieces under each arm and lightly grips the pads with the inside of the upper arm and the torso. The user then executes a golf swing while holding the pads In place throughout the swinging motion. This action or function keeps the arms “connected” to the body and keeps the golfer from swinging with the arms out of sync with the body. The body is then the primary control device for executing the golf swing which reduces extra arm motion which can cause a swing to go out of control and off the perfect swing plane of the back and forth body/arm swing motion. The result of executing a golf swing with the Athletic Swing Training Harness properly in place is a swing where the arms and the body are “connected” when the golf dub impacts the ball which delivers more control of direction of ball flight and more power resulting in the ball traveling further.

What is claimed is:

1. A halter type device allowing specialized bonded fabric and thermoformed molded pads to be Inserted under the arms to promote arms and torso to remain in contact with each other during a golf swing.

2. Pads are made from cross linked polyethylene foam of a density of 1.8-2.5 pounds per cubic foot.

3. Thermoformed pads are covered in a combination of strechy fabric for feel and the hook compatible fabric on the back to facilitate adjustment.

4. Elastic neck strap rests around neck connecting to right and left pad via Velcro stabilizer or connector to allow optimal positioning of pads in arm pit area.

5. Thermoformed foam pads have “squeeze” flexibility to allow the comfortable pressing of the upper arm and torso into the pads. This is a function of the foam formula and fabric choice.

6. Thermoformed foam pads have a ribbing which acts as a living hinge on the upper part to allow top of pad to comfortably contour around chest area.

7. An elastic connection between the pads running across the chest which adds tension between the pads so that the tension created will pull the pads out from under the arm/chest connection If not properly held in place by pressure applied by the user.
